(19) United States
(12) Patent Application Publication
(10) Pub. No.: US 2020/0363769 A1
(43) Pub. Date: Nov. 19, 2020

(54) Image Forming Apparatus

(71) Applicant: Konica Minolta, Inc., Tokyo (JP)

(72) Inventors: Shinichi KAWABATA, Tokyo (JP); Eriko KOZAKI, Tokyo (JP)

(73) Assignee: Konica Minolta, Inc., Tokyo (JP)

(21) Appl. No.: 15/931,031

(22) Filed: May 13, 2020

(30) Foreign Application Priority Data
May 16, 2019 (JP) 2019-092574

(51) Int. Cl. G03G 21/20

(52) U.S. Cl. CPC G03G 21/206

(57) ABSTRACT

An image forming apparatus includes a duct, a cyclone, a toner storage, a filter unit, a fan and a heat source. The duct sucks toner-containing air containing scattered toner. The cyclone communicates with the duct and centrifugally separates the toner from the toner-containing air. The toner storage accumulates the toner separated by the cyclone. The filter unit lets the toner-containing air, from which the toner has been separated by the cyclone, through. The fan generates airflow from the duct to the filter unit. The heat source heats the toner storage.

### CROSS-REFERENCE TO RELATED APPLICATIONS

The entire disclosure of Japanese Patent Application No. 2019-092574 filed on May 16, 2019 is incorporated herein by reference in its entirety.

### BACKGROUND

### Technological Field

The present disclosure relates to an image forming apparatus.

### Description of the Related Art

There has been known an electrophotographic image forming apparatus that forms images on sheets of paper using toner. Such an image forming apparatus uses a system of sucking scattered toner generated in a developing unit(s) and centrifuging the toner with a cyclone, thereby collecting/accumulating the toner in a toner storage and collecting, with a filter(s), the toner that has not been able to be centrifuged. (See, for example, JP 2017-90645 A).

### SUMMARY

In recent years, due to increase in productivity of such an image forming apparatus, there has been a problem that a toner storage becomes full of toner sooner than before, and accordingly needs to be replaced more often than before. Then, there has been a demand for a toner storage or a unit including the toner storage to be made usable for a longer period of time.

Increasing the size of a toner storage can make its usable time longer. However, there has been also an increasing demand for a space-saving image forming apparatus. Hence, increasing the size of a toner storage is not an appropriate solution.

The present disclosure has been made in view of the abovementioned problem(s) of the conventional technology, and objects of the present disclosure include making the usable time of a toner storage that collects/accumulates scattered toner longer and making the usable time of a unit including the toner storage longer.

According to an aspect of the present disclosure, there is provided an image forming apparatus including:

a duct that sucks toner-containing air containing scattered toner;

a cyclone that communicates with the duct and centrifugally separates the toner from the toner-containing air;

a toner storage that accumulates the toner separated by the cyclone;

a filter unit that lets the toner-containing air, from which the toner has been separated by the cyclone, through;

a fan that generates airflow from the duct to the filter unit; and

a heat source that heats the toner storage.

### BRIEF DESCRIPTION OF THE DRAWINGS

The objects, advantages, and characteristics arranged by one or more embodiments of the present invention will become more fully understood from the detailed description given hereinbelow and the appended drawings that are given by way of illustration only, and thus are not intended as a definition of the limits of the present invention, wherein:

FIG. 1 is a schematic diagram showing an overall configuration of an image forming apparatus according to an embodiment(s) of the present disclosure;

FIG. 2 is a block diagram showing a functional configuration of the image forming apparatus;

FIG. 3 schematically shows a toner collection unit;

FIG. 4 is a top view schematically showing arrangement of a toner storage, a cyclone and a filter unit;

FIG. 5 is a top view schematically showing arrangement of the toner storage and a power source; and

FIG. 6 shows the toner collection unit and components around the toner collection unit according to a second modification.

### DETAILED DESCRIPTION OF EMBODIMENTS

Hereinafter, one or more embodiments of the present invention are described in detail with reference to the drawings. However, the scope of the present invention is not limited to the embodiments or illustrated examples.

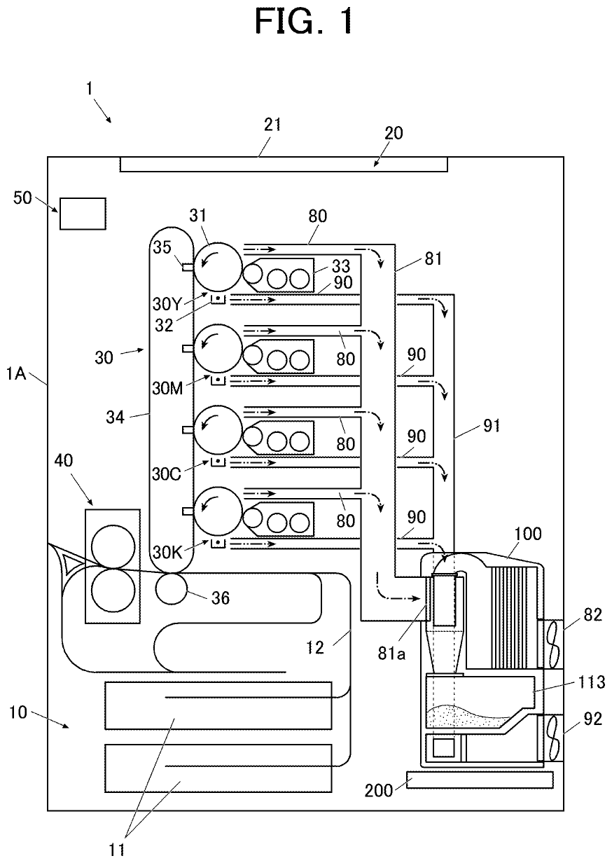

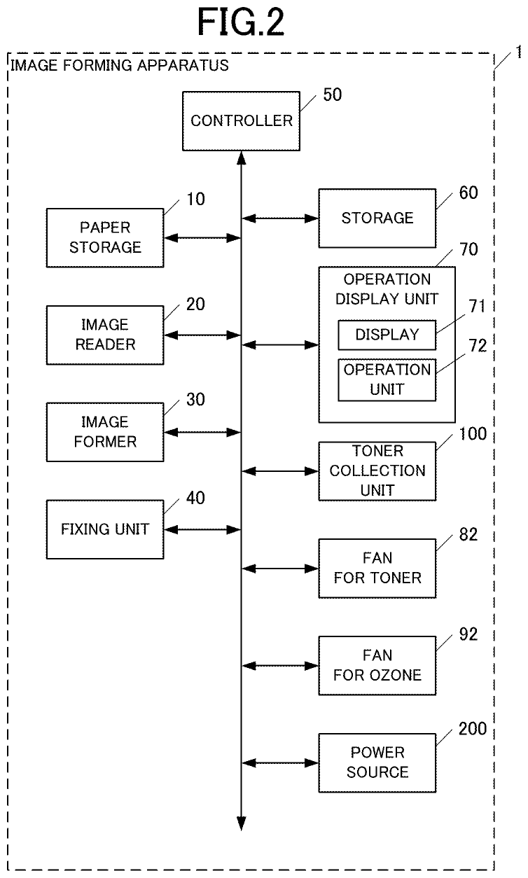

FIG. 1 is a schematic diagram showing an overall configuration of an image forming apparatus 1 according to an embodiment(s) of the present disclosure. FIG. 2 is a block diagram showing a functional configuration of the image forming apparatus 1.

The image forming apparatus 1 is a tandem electrophotographic full-color image forming apparatus that forms images on sheets of paper by superimposing four color toners of yellow (Y), magenta (M), cyan (C) and black (K) on top of one another.

The image forming apparatus 1 has a substantially cuboid body 1A that constitutes an exterior. The body 1A includes a paper storage 10, an image reader 20, an image former 30, a fixing unit 40, a controller 50 (hardware processor), a storage 60, an operation display unit 70, a toner collection unit 100, a fan 82 for toner (development suction fan), a fan 92 for ozone (charge suction fan) and a power source 200.

The paper storage 10 is arranged at the lower part of the image forming apparatus 1, and includes trays 11 for sheets of paper different in size and type. The sheets of paper are fed and conveyed from the trays 11 to a conveyor 12, and conveyed by the conveyor 12 to the image former 30 and the fixing unit 40.

The image reader 20 reads images of documents (originals) conveyed by a document conveyor (not shown) or placed on a platen 21, thereby generating image data. The image reader 20 performs processing, such as shading correction, dithering and/or compression, on the image data generated by A/D conversion, and outputs the processed image data to the controller 50.

Image data used for image forming are not limited to the data output from the image reader 20, and may be data received from an external apparatus, such as a personal computer, connected to the image forming apparatus 1.

The image former 30 forms images on sheets of paper on the basis of image data.

The image former 30 includes four image forming units 30Y, 30M, 30C, 30K for Y, M, C, K color components, an intermediate transfer belt 34, primary transfer units 35 and a secondary transfer roller 36.

Each of the image forming units 30Y, 30M, 30C, 30K includes: a drum-shaped photoreceptor 31; and a charger 32, an exposure unit (not shown), a developing unit 33 and a cleaner (not shown) arranged around the photoreceptor 31.

The charger 32 uniformly charges the surface of the photoreceptor 31. The exposure unit emits laser beams to the charged photoreceptor 31, namely exposes the charged photoreceptor 31 to laser beams, thereby forming an electrostatic latent image on the photoreceptor 31. The developing unit 33 supplies toner of a predetermined color (one of Y, M, C and K) to the exposed photoreceptor 31, thereby developing the electrostatic latent image formed on the photoreceptor 31.

The toner is composed of polymer resin, wax, a pigment and so forth. The toner has a melting point of, for example, about 40° C.

The images (single-color images) formed of toner of Y, M, C and K on the four photoreceptors 31 are transferred from the photoreceptors 31 to the intermediate transfer belt 34. The intermediate transfer belt 34 is an endless belt wound around a plurality of conveying rollers, and rotates as the conveying rollers rotate.

The primary transfer units 35 are arranged on the inner side of the intermediate transfer belt 34 so as to face their corresponding photoreceptors 31 of the image forming units 30Y, 30M, 30C, 30K. The primary transfer units 35 apply voltage having a reversed polarity of that of the toner to the intermediate transfer belt 34, thereby transferring the toner adhering to the photoreceptors 31 to the intermediate transfer belt 34.

The toner images formed by the four image forming units 30Y, 30M, 30C, 30K are sequentially transferred to the surface of the intermediate transfer belt 34. That is, on the intermediate transfer belt 34, the toner images formed of Y, M, C, K color components are superimposed, thereby forming a multi-color (full-color) toner image.

The secondary transfer roller 36 is arranged on the outer side of the intermediate transfer belt 34 so as to face the intermediate transfer belt 34. A nip part where the secondary transfer roller 36 and the intermediate transfer belt 34 contact one another is a transfer position, and the secondary transfer roller 36 brings a sheet of paper conveyed thereto by the conveyor 12 into contact with the intermediate transfer belt 34, and transfers the toner image formed on the outer surface of the intermediate transfer belt 34 to the sheet.

The fixing unit 40 is arranged on a paper ejecting side of the secondary transfer roller 36.

The fixing unit 40 includes a pair of rollers that are a heating roller and a pressure roller. The sheet is heated and pressurized by passing through a nip part formed by the pair of rollers, so that the toner image transferred to the sheet is fused and fixed there.

Suction ducts 80 for the developing units 33 are arranged near the respective developing units 33 of the four image forming units 30Y, 30M, 30C, 30K. That is, four suction ducts 80 are arranged so as to correspond to the four image forming units 30Y, 30M, 30C, 30K. The suction ducts 80 suck toner-containing air that contains toner scattered from their corresponding developing units 33 of the image forming units 30Y, 30M, 30C, 30K. In FIG. 1, flow of the toner-containing air is schematically indicated by dash-dot-dash lines with arrows.

The four suction ducts 80 are connected to a common duct 81 that is common to the developing units 33. The common duct 81 is formed to be a hollow cuboid extending in the vertical direction, and has a role of guiding the toner-containing air from the four suction ducts 80 to the toner collection unit 100.

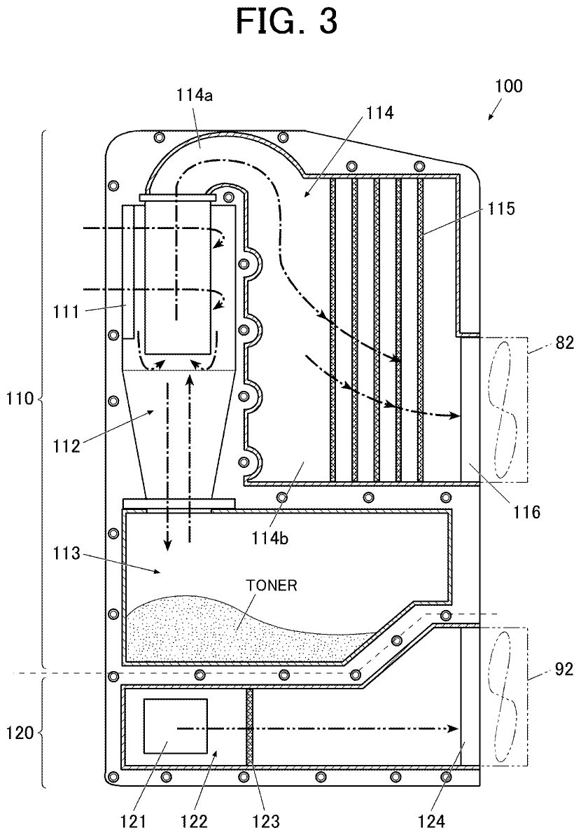

On a lateral surface of the common duct 81 facing the four image forming units 30Y, 30M, 30C, 30K, four communication ports (not shown) to which the suction ducts 80 are connected are arranged. On a side of the common duct 81 opposite to a side thereof facing the four image forming units 30Y, 30M, 30C, 30K, a connection port 81a to which an inlet 111 (shown in FIG. 3) of the toner collection unit 100 is connected is arranged.

Down a path along which air is guided to flow from the common duct 81 into the toner collection unit 100 and pass through the toner collection unit 100, the fan 82 is arranged. The fan 82 generates airflow from the suction ducts 80 to the common duct 81, to the toner collection unit 100 and then to the outside of the image forming apparatus 1, so that air flows from the suction ducts 80 and the common duct 81 into the toner collection unit 100, and then is exhausted to the outside of the image forming apparatus 1. As the fan 82, a sirocco fan, a propeller fan or the like is used.

The fan 82 also outputs a pulse signal for calculating the rotational speed (the number of rotations per unit time) to the controller 50.

Suction ducts 90 for the chargers 32 are arranged near the respective chargers 32 of the four image forming units 30Y, 30M, 30C, 30K. That is, four suction ducts 90 are arranged so as to correspond to the four image forming units 30Y, 30M, 30C, 30K. The suction ducts 90 suck ozone-containing air that contains ozone generated in their corresponding chargers 32 of the image forming units 30Y, 30M, 30C, 30K. In FIG. 1, flow of the ozone-containing air is schematically indicated by dash-dot-dot-dash lines with arrows.

The four suction ducts 90 are connected to a common duct 91 that is common to the chargers 32. The common duct 91 has a role of guiding the ozone-containing air from the four suction ducts 90 to the toner collection unit 100.

Down a path along which air is guided to flow from the common duct 91 into the toner collection unit 100 and pass through the toner collection unit 100, the fan 92 is arranged. The fan 92 generates airflow from the suction ducts 90 to the common duct 91, to the toner collection unit 100 and then to the outside of the image forming apparatus 1, so that air flows from the suction ducts 90 and the common duct 91 into the toner collection unit 100, and then is exhausted to the outside of the image forming apparatus 1. As the fan 92, a sirocco fan, a propeller fan or the like is used.

The controller 50 includes a central processing unit (CPU) and a random access memory (RAM). The CPU of the controller 50 reads various programs, such as a system program(s) and process programs, stored in the storage 60, loads the read programs to the RAM, and performs various processes in accordance with the loaded programs.

The storage 60 includes a hard disk drive (HDD) and/or a nonvolatile semiconductor memory.

The storage 60 stores various programs, such as the system program(s) and the process programs, which are executed by the controller 50, and data necessary for execution of these programs.

The operation display unit 70 includes: a display 71 that has a display screen and displays various types of information on the screen; and an operation unit 72 that is used by a user to input various instructions.

The toner collection unit 100 (cyclone unit) is formed such that its external shape is a substantially cuboid, and is attachable to and detachable from the body 1A.

FIG. 3 schematically shows the toner collection unit 100. As shown in FIG. 3, the toner collection unit 100 includes a toner separator 110 (toner processor) and an ozone remover 120 (ozone processor). In FIG. 3, airflow in the toner separator 110 is schematically indicated by dash-dot-dash lines with arrows, and airflow in the ozone remover 120 is schematically indicated by a dash-dot-dot-dash line with an arrow.

The toner separator 110 includes the inlet 111, a cyclone 112, a toner storage 113, an airflow part 114, a filter unit 115 and an outlet 116.

The inlet 111 is a receiving port that receives the toner-containing air having passed through the common duct 81. When the toner collection unit 100 is mounted on the body 1A, the inlet 111 faces the connection port 81a of the common duct 81. This makes the cyclone 112 communicate with the inner space of the common duct 81 via the inlet 111.

The cyclone 112 centrifuges the toner-containing air having passed through the common duct 81 and flowed into the cyclone 112 via the inlet 111, thereby separating toner from the toner-containing air. The cyclone 112 is formed to be cylindrical, and has an axial direction that coincides with the vertical direction (direction in which gravity acts).

The cyclone 112 is formed so as to taper, thereby reducing its inner diameter, toward an opening formed in an end thereof closer to the toner storage 113.

The toner-containing air having flowed into the cyclone 112 travels in the tangential direction of the inner circumference of the cyclone 112. This generates, in the cyclone 112, swirl flow of the air swirling.

The toner on the swirling flow moves radially by centrifugal force, which is generated by a circular motion of an object. Consequently, most of the toner is (centrifugally) separated from the air. The toner separated by the cyclone 112 falls down by its own weight and is accumulated in the toner storage 113. Meanwhile, air flows from the lower end of the cylindrical part of the cyclone 112 into the cyclone 112, and enters an inflow part 114a of the airflow part 114 arranged above the cyclone 112.

The airflow part 114 includes the inflow part 114a that communicates with the cyclone 112 and a filter-arranged part 114b that communicates with the inflow part 114a.

The inflow part 114a is formed in the shape of a U-shaped pipe, and vertically turns over and guides, to the filter-arranged part 114b, the air that flows from the cyclone 112.

In the filter-arranged part 114b, the filter unit 115 that filters out toner is arranged.

The filter unit 115 collects the toner contained a little in the air having passed through the cyclone 112. Thus, the air is cleaned by passing through the filter unit 115. The filter unit 115 has toner/dust-proof filters arranged so as to be superposed (or overlapped) in a direction in which the air passes. The filter unit 115 may include an ozonolysis filter(s).

The air having passed through the filter unit 115 flows out from the outlet 116, which is formed downstream in the air flowing direction (on a side opposite to a side where the cyclone 112 is arranged), to the fan 82.

Thus, the air sucked by the suction ducts 80 passes through the common duct 81, the inlet 111, the cyclone 112, the inflow part 114a, the filter-arranged part 114b (filter unit 115) and the outlet 116, and thereafter passes through the fan 82, thereby being exhausted to the outside of the image forming apparatus 1. A path configured to guide air from the suction ducts 80 to the fan 82 so that toner is separated from the air containing toner scattered from the developing units 33 is called toner path (development suction path).

The fan 82 is arranged near the toner storage 113 on a lateral surface of the toner collection unit 100 opposite to a lateral surface thereof where the cyclone 112 is arranged. The fan 82 generates airflow from the ducts (suction ducts 80, common duct 81) to the filter unit 115.

The ozone remover 120 includes an inlet 121, an airflow part 122, a filter unit 123 and an outlet 124.

The inlet 121 is a receiving port that receives the ozone-containing air having passed through the common duct 91. In FIG. 3, the ozone-containing air flows from the back side of the inlet 121 to the front side.

The airflow part 122 is a flow path that the air having flowed from the inlet 121 passes through.

In the airflow part 122, the filter unit 123 is arranged.

The filter 123 has an ozonolysis filter, and removes ozone from the ozone-containing air.

The air having passed through the filter unit 123 flows out from the outlet 124, which is formed downstream in the air flowing direction, to the fan 92.

Thus, the air sucked by the suction ducts 90 passes through the common duct 91, the inlet 121, the filter unit 123 and the outlet 124, and thereafter passes through the fan 92, thereby being exhausted to the outside of the image forming apparatus 1. A path configured to guide air from the suction ducts 90 to the fan 92 so that ozone is removed from the air containing ozone generated in the chargers 32 is called ozone path (or charge suction path).

The ozone path (ozone remover 120) in the toner collection unit 100 is arranged under the toner storage 113 but above the power source 200 (heat source) (shown in FIG. 1).

The toner collection unit 100 is formed by the toner separator 110 including the cyclone 112, the toner storage 113 and the filter unit 115 being united with the ozone remover 120. The toner storage 113 is attachable to and detachable from the toner collection unit 100, and hence replaceable independently when becoming full of toner.

The power source 200 is a power source of the image forming apparatus 1, and supplies power to the components of the image forming apparatus 1. The power source 200 is arranged under the toner storage 113, and functions as a heat source that heats the toner storage 113. The toner in the toner storage 113 melts at about 40° C. or higher. As the toner in the toner storage 113 melts, the bulk density increases and accordingly the amount of toner storable in the toner storage 113 increases.

It is preferable that the power source 200 be arranged such that the power source 200 heats the toner storage 113, but the heat is not transferred to the cyclone 112.

When the cyclone 112 is heated, the toner in the cyclone 112 melts and becomes sticky, and adheres to the opening formed in the end closer to the toner storage 113, the inner wall of the cyclone 112 and so forth. This makes centrifugation difficult. Hence, it is preferable that the cyclone 112 be away from the heat source. Further, conventionally, in the cyclone 112, an axial rod component is arranged to adjust the airflow, but in this embodiment, no axial rod component is arranged. Consequently, heat is hardly transferred from the toner storage 113 to the cyclone 112.

The power source 200 used as the heat source may be one that supplies power to some of the components of the image forming apparatus 1. For example, the power source 200 used as the heat source may be a power source of a unit (e.g. operation display unit 70) constantly (always) operating during operation of the image forming apparatus 1. Alternatively, the power source 200 used as the heat source may be a power source of the fan 82.

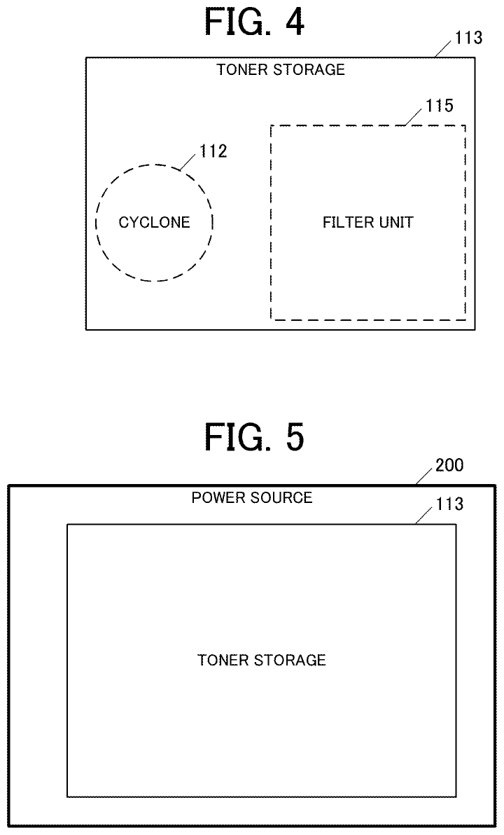

FIG. 4 is a top view schematically showing arrangement of the toner storage 113, the cyclone 112 and the filter unit 115. The bottom area of the toner storage 113 is larger than the bottom area of the cyclone 112. The bottom area of the toner storage 113 is larger than the bottom area of the filter unit 115, too.

FIG. 5 is a top view schematically showing arrangement of the toner storage 113 and the power source 200. The bottom area of the power source 200 (heat source) is larger than the bottom area of the toner storage 113.

The controller 50 calculates the rotational speed (the number of rotations per unit time) of the fan 82 on the basis of the pulse signal output from the fan 82.

When the image forming apparatus 1 starts image forming, as toner is accumulated in the toner storage 113 and collected by the filter unit 115, the flow rate of the air passing through the fan 82 decreases. As the rotational load of the fan 82 being driven with a predetermined voltage decreases, the rotational speed thereof increases. After the toner storage 113 becomes full of toner, the toner in the toner storage 113 swirls up and causes clogging in the filter unit 115, so that the rotational speed of the fan 82 rapidly increases.

The controller 50 detects that the toner storage 113 is full of toner when the rotational speed of the fan 82 reaches a predetermined value or higher, on the basis of change in the rotational speed of the fan 82.

As described above, according to this embodiment, the power source 200 (heat source) heats the toner storage 113 that collects/accumulates the scattered toner. Consequently, the toner in the toner storage 113 melts and toner particles thereof closely adhere to one another. This can increase the bulk density of the toner and accordingly increase the amount of toner storable in the toner storage 113, and therefore make the usable time of the toner storage 113 longer without increasing the size of the toner storage 113.

The toner collection unit 100 can be replaced when the toner storage 113 becomes full of toner. This can make the usable time of a unit (toner collection unit 100) including the toner storage 113 longer.

Increasing the amount of toner storable in the toner storage 113 can delay occurrence of clogging in the filter unit 115, and make the usable time of the filter unit 115 longer.

Further, the power source 200 (heat source) is arranged under the toner storage 113. This can warm up the toner storage 113 efficiently.

Further, the power source 200 is used as the heat source. This can eliminate necessity to provide another component used for heating only. For example, a power source of a unit (e.g. operation display unit 70) constantly operating during operation of the image forming apparatus 1 may be used as the heat source. This can keep warming up the toner storage 113. Alternatively, a power source of the fan 82 may be used as the heat source. This can warm up the toner storage 113 when the toner-containing air flows into the toner collection unit 100.

The power source 200 used as the heat source may be a power source of the fan 92.

Further, the cyclone 112 is formed so as to taper, thereby reducing its inner diameter, toward the opening in the end closer to the toner storage 113. Consequently, heat is hardly transferred from the toner storage 113 to the cyclone 112.

Further, the fan 82 is arranged near the toner storage 113 on the lateral surface of the toner collection unit 100 opposite to the lateral surface thereof where the cyclone 112 is arranged. Consequently, heat from the toner storage 113 is released by the fan 82, and also hardly transferred to the cyclone 112.

Further, the ozone path is arranged under the toner storage 113 but above the power source 200 (heat source). Consequently, heat of the power source 200 is hardly transferred to the cyclone 112, and also promotes ozonolysis. This can make the usable time of the filter unit 123 arranged in the ozone path longer.

The ozone path is not limited to being arranged under the toner storage 113, and hence may be arranged adjacent to the toner storage 113 in the horizontal direction.

Further, the bottom area of the toner storage 113 is larger than the bottom area of the cyclone 112 and larger than the bottom area of the filter unit 115. This can ensure the amount of toner storable in the toner storage 113.

Further, the bottom area of the power source 200 (heat source) is larger than the bottom area of the toner storage 113. This can warm up the toner storage 113 efficiently.

### First Modification

In a first modification, the temperature of the heat source is changeable.

The controller 50 changes the temperature of the power source 200 (heat source) in accordance with the rotational speed of the fan 82.

For example, as the rotational speed of the fan 82 becomes faster, that is, as the amount of toner entering the toner collection unit 100 becomes larger, the controller 50 increases the temperature of the power source 200 and accordingly increases the amount of toner storable in the toner storage 113.

A situation where the rotational speed of the fan 82 increases will be described. As the filter unit 115 collects toner, the flow rate of the air passing through the fan 82 decreases, the rotational load of the fan 82 decreases, and the rotational speed of the fan 82 increases.

The rotational speed of the fan 82 may be controlled in accordance with image density (coverage). When the image density is equal to or higher than a predetermined value, the controller 50 sets output of the fan 82 to 100% (assuming that its default setting is 80%, for example) because the amount of toner scattered from between the developing units 33 and their corresponding photoreceptors 31 increases.

According to the first modification, the temperature of the power source 200 (heat source) is changed in accordance with the rotational speed of the fan 82. This can reduce the bulk density when the amount of toner used/scattered is large.

### Second Modification

In a second modification, heat of the heat source is transferred to the entire toner storage 113.

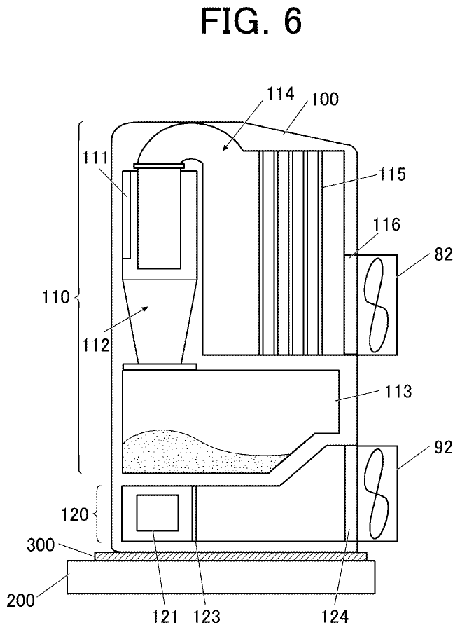

FIG. 6 shows the toner collection unit 100 and components around the toner collection unit 100 according to the second modification.

Between the power source 200 (heat source) and the toner storage 113, a diffusion component 300 where heat of the power source 200 diffuses and that transfers the heat is arranged. The diffusion component 300 is made of sheet metal.

Between the power source 200 and the toner storage 113, a component(s) other than the diffusion component 300 may be arranged. In the case shown in FIG. 6, between the power source 200 and the toner storage 113, the ozone path (ozone remover 120) is arranged. The power source 200 heats the diffusion component 300, so that the heat diffuses throughout the diffusion component 300. The diffusion component 300 transfers the heat to the bottom surface of the toner storage 113 via the ozone path.

The diffusion component 300 is arranged at least between the bottom surface of the toner collection unit 100 and the heat source. The diffusion component 300 may be arranged so as to be continuous from the bottom surface of the toner collection unit 100 to the lateral surfaces of the toner collection unit 100. However, in order to avoid heating the cyclone 112, it is preferable that the diffusion component 300 be arranged so as not to overlap or cover the cyclone 112.

According to the second modification, the diffusion component 300 is arranged between the power source 200 (heat source) and the toner storage 113. Even when the diffusion component 300 is partly heated, the heat diffuses throughout the diffusion component 300. This can warm up the entire toner storage 113.

Those described in the above embodiment, first modification and second modification are examples of the image forming apparatus according to the present disclosure, and not intended to limit the present invention. The detailed configuration and detailed operation of each component of the image forming apparatus can be appropriately modified without departing from the scope of the present invention.

For example, although in the above embodiment, first modification and second modification, the power source 200 is used as the heat source, a heater dedicated to heating the toner storage 113 may be used.

Further, although in the above embodiment, first modification and second modification, the ozone path is arranged separately from the toner path, the toner path may double as the ozone path, or the ozone path may join the toner path at a point.

Although some embodiments or the like of the present invention have been described and illustrated in detail, the disclosed embodiments or the like are made for purposes of not limitation but illustration and example only. The scope of the present invention should be interpreted by terms of the appended claims.

What is claimed is:

1. An image forming apparatus comprising:
a duct that sucks toner-containing air containing scattered toner;
a cyclone that communicates with the duct and centrifugally separates the toner from the toner-containing air;
a toner storage that accumulates the toner separated by the cyclone;
a filter unit that lets the toner-containing air, from which the toner has been separated by the cyclone, through;
a fan that generates airflow from the duct to the filter unit; and
a heat source that heats the toner storage.

2. The image forming apparatus according to claim 1, wherein the heat source is disposed under the toner storage.

3. The image forming apparatus according to claim 1, wherein the heat source is a power source of the image forming apparatus.

4. The image forming apparatus according to claim 3, wherein the power source as the heat source is a power source of a unit constantly operating during operation of the image forming apparatus.

5. The image forming apparatus according to claim 3, wherein the power source as the heat source is a power source of the fan.

6. The image forming apparatus according to claim 1, further comprising a hardware processor that changes a temperature of the heat source in accordance with a rotational speed of the fan.

7. The image forming apparatus according to claim 1, further comprising a diffusion component where heat of the heat source diffuses and that transfers the heat, the diffusion component being disposed between the heat source and the toner storage.

8. The image forming apparatus according to claim 1, wherein the cyclone is formed so as to be cylindrical and to taper, thereby reducing an inner diameter, toward an opening in an end closer to the toner storage.

9. The image forming apparatus according to claim 1,
wherein the cyclone, the toner storage and the filter unit are united with one another, thereby configuring a toner collection unit, and
wherein the fan is disposed near the toner storage on a lateral surface of the toner collection unit opposite to a lateral surface thereof where the cyclone is disposed.

10. The image forming apparatus according to claim 1,
wherein the cyclone, the toner storage and the filter unit are united with one another, thereby configuring a toner collection unit, and
wherein the toner storage is attachable to and detachable from the toner collection unit.

11. The image forming apparatus according to claim 1, further comprising:
a charger that charges a photoreceptor; and
an ozone path configured to guide ozone-containing air containing ozone generated in the charger so that the ozone is removed from the ozone-containing air, wherein
the ozone path is disposed under the toner storage but above the heat source.

12. The image forming apparatus according to claim 1, wherein a bottom area of the toner storage is larger than a bottom area of the cyclone and larger than a bottom area of the filter unit.

13. The image forming apparatus according to claim 1, wherein a bottom area of the heat source is larger than a bottom area of the toner storage.
